(19) United States
(12) Patent Application Publication
(10) Pub. No.: US 2013/0074667 A1
(43) Pub. Date: Mar. 28, 2013

(54) DEVICE FOR SLICING A FOOD PRODUCT AND DEVICE WITH A ROBOT

(71) Applicant: Weber Maschinenbau GmbH Breidenbach, Breidenbach (DE)

(72) Inventors: Guenther Weber, Gross Nemerow (DE); Ingo Rother, Breidenbach (DE)

(73) Assignee: Weber Maschinenbau GmbH Breidenbach, Breidenbach (DE)

(21) Appl. No.: 13/624,514

(22) Filed: Sep. 21, 2012

(30) Foreign Application Priority Data
Sep. 22, 2011 (DE) 10 2011 114 180.8

(51) Int. Cl. B26D 5/20; B26D 7/32; B26D 7/06

(52) U.S. Cl. 83/73; 83/72; 83/78

(57) ABSTRACT

The present invention relates to a device for slicing a food product (1), wherein a control system is adapted to monitor at least one status parameter, and to determine, in dependency on the at least one status parameter and at least one specification, whether a predefined condition was met, which especially requires a maintenance measure. The invention further relates to a device with a robot (18) for displacing a food product, wherein a control system is adapted to monitor at least one status parameter, and to determine, in dependence on the at least one status parameter and a motion program, whether a predefined condition was met, which especially requires a maintenance measure. The present invention furthermore relates to a device for slicing a food product (1), wherein at least one camera (15, 16, 17) is provided, which is adapted to capture at least one piece of information in relation to the cutting unit (3) and/or the food product (1) and the food product slices (7), respectively. The invention moreover relates to a device with a robot (18) for displacing a food product, wherein at least one camera (30, 31) is provided, which is adapted to capture information in relation to the robot (18) and/or the food product.

### CROSS-REFERENCE TO RELATED APPLICATIONS

This application claims priority to German Patent Application 10 2011 114 180.8 filed on Sep. 22, 2011, which is hereby incorporated by reference in its entirety.

### TECHNICAL FIELD

The present disclosure relates to a device for slicing a food product and a device with a robot for displacing a food product.

### BACKGROUND

Devices for slicing food products are known from the state of the art. For example, the devices may be slicers comprising a cutting unit with a rotating cutter knife which can be driven by a drive, and a product feeder that feeds the food product to the cutting unit, and a receiving unit which adapted to receive the slices of food products that are sliced from the food product. In addition, these kinds of slicers have a control system that guides the cutting process.

Further, devices with a robot are known from the state of the art for displacing food products, in particular food product slices, wherein the robot comprises at least one robot arm, which has a gripping unit for grabbing food products, and wherein the robot is adapted to pick up the food products from a surface and to transfer them to a desired location. These devices may also comprise a control system which stores at least one specification for a motion program for the robot and which conducts the control of the robot.

Starting from the state of the art, the object of the disclosure is to increase the operational safety of the device during use in production.

### SUMMARY

The object of the disclosure is solved by a device for slicing a food product, with a cutting unit, in particular with a rotating cutter knife, which can be driven by a drive, a product feeder which feeds the food product to the cutting unit, a receiving unit, which is adapted to receive food product slices which are sliced from the food product, and a control system, in which at least one specification or desired value is stored. According to the disclosure, the control system is adapted to monitor at least one status parameter and to determine, in dependency of the at least one status parameter and the at least one selected specification, whether a predefined condition was met which, in particular, requires a maintenance measure. Due to the combination of the monitoring of the status parameter and the specification, it is possible to provide significant information about the state of the device which information enable to predict whether and in particular when a failure of the device is lying ahead or a maintenance measure is necessary. The status parameters may be values to be obtained within the device which may be obtained by any desired sensors. The specification is especially information transmitted to the control system which information influences the control properties or feedback control properties of the control system.

The continuous monitoring of the status parameters enables to predict the point of time of the occurrence of an operational status which fulfils a predefined condition. Such an operational status is, in particular, an operational failure or an under-performance of the device. Thereby, on the one hand, the maintenance interval may be optimally adjusted and on the other hand, countermeasures may be taken at an earlier time which can delay the occurrence of the predefined condition.

Food products which are sliced by the device according to the present disclosure are, in particular, food rods, such as cheese rods, sausage rods or ham rods but also products which have a variable form along their longitudinal direction, such as naturally formed ham or cheese.

The control system is especially adapted to store at least one specification for a slicing or cutting program, which specification is chosen from a plurality of specifications for slicing or cutting programs wherein the control system is further adapted to determine, in dependency on the at least one status parameter and the at least one selected specification of the slicing program, whether the predefined condition was met.

In one embodiment, one status parameter is the temperature of the drive. For this purpose, in particular, a temperature sensor may be utilized which is either directly attached at the drive or carries out the temperature by an infrared measurement at a certain distance from the drive.

Based on the temperature of the drive, for example, conclusions may be made about the power of the drive. By the power of the drive then, the sharpness of the cutting knife may be evaluated in dependency on a selected specification, in particular, a cutting speed and/or the viscosity of the food product to be sliced, which sharpness may be converted to the wear of the cutting knife. The predetermined condition may be, for example, that the cutting knife has a certain sharpness and the maintenance measure may be a re-sharpening or replacing of the cutting knife.

The drive is, in particular, an electric motor and the status parameter is the motor current of the electric motor. Therewith, the power of the electric motor may also be determined and therefrom, for example, meeting of the predefined condition relating to the necessity of re-sharpening or the replacement of the cutting knife may be determined.

By the evaluation previously described especially the lifetime of the cutting knife may be determined.

In an embodiment, a gripper with a gripping drive is provided wherein the gripper is adapted to be brought into engagement with the food product during the slicing of the food product and wherein the status parameter is the motor current of the gripper drive. In particular, the gripper is brought into engagement with the end of the food product which lies opposite to the end of the food product facing the cutting unit. The gripper may, on the one hand, serve for enabling the product feeding of the food product. Additionally or alternatively, the gripper may serve for stabilizing the end of the food product held by the gripper during the slicing procedure. Due to the capturing of the motor current as a status parameter, in particular, the power of the gripper drive or a gripper jaw drive may be especially evaluated as to whether the gripper drive or the gripper jaw drive are functioning properly. Therefore, this status parameter is computed together with a selected specification, such as the feed rate of the gripper or the predefined gripper jaw movement, and it is determined whether the predefined condition is met that the gripper drive or the gripper jaw drive does not function properly anymore.

In an embodiment, the status parameter is the cutting pressure of the cutting unit. Based on the cutting pressure, it may be determined by means of the known specifications, in particular, by the rotational speed of the cutting knife and the viscosity of the food product to be sliced as well as the geometry of the food product to be sliced, whether the drive of the cutting unit is functioning properly or whether the cutting knife has to be re-sharpened or replaced.

In an embodiment, the status parameter is a vibrational frequency and/or vibrational intensity at the device. From the vibrational intensity and the specifications of the control system, a plurality of predefined conditions may be determined, for example, in relation to a proper function of the cutting knife, the product feeder and the drive of the cutting unit. If, for example, a deviation of the rotational speed of the rotating cutting knife from the specified rotational speed occurs, this can be easily determined by the determination of the vibrational frequency and/or vibrational intensity. Blunting of the cutting knife may lead to an increase of the vibrational intensity since a higher resistance is set against the cutting process. Furthermore, it may be determined by the vibrational frequency and/or vibrational intensity, whether imbalances are at hand.

In an embodiment, a status parameter is the oscillating intensity or oscillating frequency of the cutting edge of the cutting knife. Therefore, an acceleration sensor may be directly attached or mounted to the cutting knife. Alternatively, also by means of a distance measurement, for example, by means of a laser sensor, the oscillation intensity or oscillation frequency of the cutting edge may be determined. Furthermore, also a strain gauge may be attached or mounted to the cutting knife by means of which strain gauge, the dynamic deformation of the cutting knife may be captured and therefrom, the oscillation intensity or oscillation frequency may be determined.

In an embodiment, one status parameter is the temperature of the food product directly before the slicing or of the sliced food product slices directly after the slicing. The temperature may, in particular, be carried out by an infrared temperature measurement. Based on the temperature of the food product at the cutting edge, for example, the wear of the cutting knife may be concluded.

The specifications of the slicing program may, in particular, comprise the cutting speed of the cutting unit, the type of food product and/or the feed rate of the food product. The type of food product is a product-specific specification and comprises especially the viscosity or toughness, respectively, and the thickness and/or cross-sectional form of the food product. The specifications for the cutting program are furthermore derived values such as the slice thickness of the sliced food product. Also, specifications specific to the device are possible for the cutting program, such as the motor current, the rotational speed of the motor, the control current for the feed rate or the forward speed of the product feeding.

In an embodiment, the control system is adapted to compute a specification of the cutting program with the at least one status parameter in order to determine whether the predefined condition was reached or met. For example, this may be calculated from a specification of the cutting program, namely, the speed of slicing, and the status parameter whether the cutting knife is already worn out.

The predetermined condition is especially met when leaving a tolerance range for a status parameter wherein the tolerance range may result in dependency on the at least one specification of the cutting program. For this purpose, the tolerance region may be a set which is limited on one side or two sides. As an alternative to the tolerance region, a tolerance space for a plurality of status parameters may be calculated in dependency on the at least one specification of the cutting program, wherein the dimension of the tolerance region corresponds to the number of monitored status parameters. For example, a maximum or minimum motor current may be determined for a certain type of food rod, which motor current ensures a proper operation of the slicing device. If this tolerance region is left by the motor current as a status parameter, the predefined condition is considered as being met and a maintenance measure is required, for example, the replacement of the cutting knife.

In an embodiment, the cutting knife of a cutting unit is equipped with a sensor for capturing the at least one status parameter. The sensor may, in particular, capture the speed, acceleration or temperature of the cutting knife as a status parameter wherein therefrom, conclusions about the state of wear of the cutting knife may be drawn under consideration of the specification.

The object underlying the disclosure is furthermore solved by a device with a robot for displacing a food product, in particular, food product slices, wherein the robot comprises at least one robot arm on which a gripping unit for grabbing the food products is located, and wherein the robot is adapted to pick up the food products from a surface and to displace the food products to a desired location, wherein the device comprises a control system within which at least one specification for a motion program for the robot is stored. The gripping unit is to be understood as a general handling unit and comprises gripping units, which grip the food products from beneath at one or two sides, but also tray-like gripping units which only form a support surface for the food product. In particular the tray-like support surface may be designed as a conveyor belt, which facilitates the receipt and delivery of the food products. According to the disclosure, the control system is adapted to monitor at least one status parameter and to determine, in dependency on the at least status parameter and the motion program, whether a predefined condition is met, which predefined condition especially requires a maintenance measure. Due to determining in dependency on the status parameter and motion program whether a predefined condition is met, a precise monitoring of the proper operation of the robot may be assured.

The continuous monitoring of the status values enables to predict the point of time of the occurrence of an operational status which fulfils a predefined condition. Such an operational status is especially an operational failure or an under-performance of the device. Thereby, the maintenance interval may, on the one hand, be adapted in a flexible and interactive manner and on the other hand, countermeasures may be taken at an early time which can delay the occurrence of the predefined condition.

In an embodiment, the control system is adapted to store at least one specification for a motion program which specification is selected from a plurality of specifications for motion programs where the control system is furthermore adapted to additionally determine in dependency of the at least one selected specification whether the predefined condition was met. The specifications for the motion program are, in particular, the speed and trajectories of the robot arm and the movements of the gripper.

In an embodiment, the robot arm has an electric drive and a status parameter is the supply current of this drive. Should a discrepancy now occur between the selected motion program and the supply current required therefore, the predefined condition is met and it is especially displayed to an operator that the robot requires maintenance.

Alternatively or additionally, a status parameter may be the temperature of the electric drive. Therefrom, also the power of the electric drive may be concluded and thereby it may be determined in dependency on the motion program, whether the predefined condition is met.

In an embodiment, the status parameter is the position and/or speed of the at least one robot arm, wherein this position and/or speed is in particular captured by means of an incremental encoder. If differences between the position and/or speed of a robot arm and the specifications of the motion program pertaining thereto or derived specifications of the motion program occur, then it may also be concluded that a maintenance measure for the robot is required.

In an embodiment, a camera may be provided which captures the at least one status parameter of the device. The status parameter may be calculated, for example, by image processing of the images captured by the camera. For example, the position of the robot or the speed of the robot may be determined by the camera. The camera may also capture status parameters of the slicing device for slicing a food product.

In an embodiment, the camera and the control system are adapted to determine the position of food product slices as a status parameter. Therewith, it may be determined on the one hand, whether the food product slices are fed to the robot at the predefined position. Furthermore, it may also be determined whether the robot deposits the food product slices at a designated position. Should discrepancies occur between the predefined position for the deposition of the food product slices, which positions are determined by the motion program and the actual position of deposition, a maintenance measure may be required. With the device for slicing food products it may be verified whether the slices come to rest at a predefined location after the cutting procedure.

The camera and the control system may be especially adapted to determine a centre point of the food product slices as a status parameter. This is especially possible by capturing the contour of the food product slices by image processing and by computing the centre point therefrom.

In an embodiment, the control system is adapted to adjust an operational parameter at the device if a predefined condition is met. This means that instead of an immediate requirement of carrying out maintenance, an adjustment of the operation of the device may also take place. The adjustment of the operational parameter may especially mean that the drives of the device are slowed down or shut off. Furthermore, the operational parameter may require an adjustment of the motion program. Thereby, the device may be further operated until maintenance is carried out at a suitable point of time.

The control system may be advantageously adapted to output a warning signal if the predefined condition was met. This warning signal may be output acoustically or via a control panel. In other embodiments, the warning signal may be output to mobile terminal devices or to a central monitoring terminal.

The control system may be adapted so that at least one status parameter is monitored continuously. This is especially the case in analogue control systems. In particular, a voltage value captured by the sensor as a status parameter may be compared to a reference voltage value wherein the reference voltage value may be defined in dependency on the specifications of the cutting program or the motion program.

In other embodiments, it is possible that the control system is adapted so that at least one status parameter is monitored at discrete sampling times. This is especially the case with digital control systems.

The control system may be adapted to determine by evaluating at least one status parameter of different points of time, whether the predefined condition has been reached, in particular, the change of the status parameter may provide information about and to what extent a component of the device requires maintenance. For example, the predefined condition may be reached by an increase of the motor current or a temperature, by a decrease of a precision of motion or by an increase of a vibrational intensity and thereby a maintenance measure may be required.

In an embodiment, the control system is adapted to take into account at least status parameters in the calculation of the predefined condition. For example, the speed of a drive may influence the calculation of a predefined condition especially in relation to a maximum temperature of a drive.

In an embodiment, a memory element is provided which is adapted to store the status parameters. This especially has the advantage that the development of the status parameters may be read out in order that additional information in relation to the operation of the device may be gained. Thereby, countermeasures may especially be taken which lead to a longer operation of the device without maintenance. Furthermore, the memory element may provide status parameters over different points of time which are analyzed whether thereby the predefined condition was met. In particular, the change of a status parameter over time may influence the analysis of the predefined condition.

Furthermore, the object is solved by a device for slicing a food product, comprising a cutting unit, in particular, a rotating cutting knife, which is drivable by a drive, a product feeder which feeds the food product to the cutting unit and a receiving unit which is adapted to receive slices of the food product which are cut off from the food product. According to the disclosure, at least one camera is provided which is adapted to capture at least information in relation to the cutting unit and/or the food product, respectively the slices of the food product.

By providing a camera for monitoring the operation of the device of the generic type especially of a slicer, the proper function of the device may be monitored and it may already be evaluated at an earlier point of time whether a failure or requirement for maintenance is at hand. In particular, the information captured by the camera is processed in a processing unit in order to determine abstract values therefrom. Therefore, an image processing and a logical processing of the result of the image processing are carried out.

In an embodiment, the camera is adapted to monitor the orientation of the food product. Thereby, a proper feeding of the food product may be assured.

The camera is advantageously adapted to monitor the structure or size of the food product slices. Thereby, the products produced in the cutting unit may be analyzed and evaluated and the malfunctions may especially be detected at an earlier point of time especially if the result of the cutting does not correspond to the product-specific specifications.

Furthermore, the camera may be adapted to monitor the wear of the cutting knife. Therefore, the camera may especially capture the form of a cutting knife and may compare the form to a predefined form. Thereby, for example, it may be recognized whether the cutting edge is still tapering off sufficiently enough or in such a manner that it no longer meets the specifications. The form of the cutting knife may especially be determined when the cutting knife is halted.

The camera may also be adapted to determine the form of the inserted or loaded cutting knife. Thereby, it may be especially determined whether the form meets the specifications for the cutting knife to be used which may also depend on the cutting program.

It may especially be determined whether the cutting knife is original equipment and therefore suited for the operation in the cutting unit.

The object of the disclosure is furthermore solved by a device with a robot for displacing a food product, in particular, food product slices, wherein the robot has at least one robot arm, at which a gripping unit for gripping the food product is located, and wherein the robot is adapted to take up food products from a surface and to displace them to a desired location. The gripping unit is to be understood as a general handling unit and comprises gripping units, which grip the food products from beneath at one or two sides, but also tray-like gripping units which only form a support surface for the food product. In particular the tray-like support surface may be designed as a conveyor belt, which facilitates the receipt and delivery of the food products. According to the disclosure, a camera is provided which is adapted to capture information in relation to the robot and/or the food product. Thereby, the proper operation and the requirement of maintenance of the robot may be monitored.

The camera may especially be adapted to determine the position of the food product slices. The position of the food product slices may be determined on the surface and/or at the desired location to which they are displaced. Especially, the final position of the food products at the desired location provides information about the proper operation of the robot. The position of the food products on the surface may be used for adjusting the trajectory of the robot so that the food products may be optimally taken up.

The camera is especially adapted to determine the centre point of the food product slices. This can be enabled by a processing unit assigned to the camera. By a change of the respective centre points of different food product slices at the desired location in subsequent displacement processes of the food product it may be determined that the function of the robot is no longer proper. Furthermore, it may be predicted when a maintenance of the robot is required.

In an embodiment, the camera is adapted to determine the position of the gripping unit. Especially, limits of motion may be monitored so that the robot remains in a predefined area.

In an embodiment, the device for slicing from a food product or the device with a robot has a control system which is adapted to monitor at least one status parameter which is determined by the information provided by the camera and to determine whether in dependency of the at least one status parameter, a predefined condition was met, which requires a measure especially a maintenance measure. The status parameter may correspond to all previously mentioned values which are determined by the camera or may correspond to values derived therefrom. Furthermore, a specification may be considered which may be predefined in the control system of the device by the operator.

In an embodiment, a memory element is provided which is adapted to store information captured by the camera. Thereby, the change of a status parameter or other information determined by the camera over the time may especially be determined and thereby a precise prediction about the proper operation or the requirement of maintenance of the device can be made. Furthermore, the information in the memory element may be checked after a failure or during maintenance in order to see how far the relevant information in relation to the system has changed during the operation, so that appropriate adjustments especially of the control specifications of the device can be carried out.

Furthermore, settings of the cutting unit may be monitored with the camera. The relative orientation and inclination of the members of the cutting unit or of the robot may especially be monitored. For example, the inclination of the product feed, the speed of the product feeder, the position of the cutting unit with respect to the product feeder and the position of the receiving unit with respect to the cutting unit or the position of the robot gripping unit or of the robot arms may be monitored. Moreover, the limit stops may be monitored, especially whether the food product is in abutment with the cutting unit, furthermore, whether the food product is in abutment with an gripper optionally provided at the opposing end of the cutting unit.

The cleanliness of the device can be monitored since stains may be recognized by the camera and the processing unit.

In some embodiments, the type of the food product may be determined by the camera in order to validate whether the selected cutting program or motion program is suitable for the food product. Furthermore, abnormalities or damages to the device as well as to the food product may also be captured by the camera and the processing unit.

### BRIEF DESCRIPTION OF THE DRAWINGS

The disclosure is now explained by preferred embodiments by reference to the following Figures:

FIG. 1 shows a schematic cross-sectional view of an embodiment of a device according to the disclosure for slicing a food product.

FIG. 2 shows a three dimensional view of an embodiment of a device according to the disclosure with a robot for displacing a food product.

### DETAILED DESCRIPTION

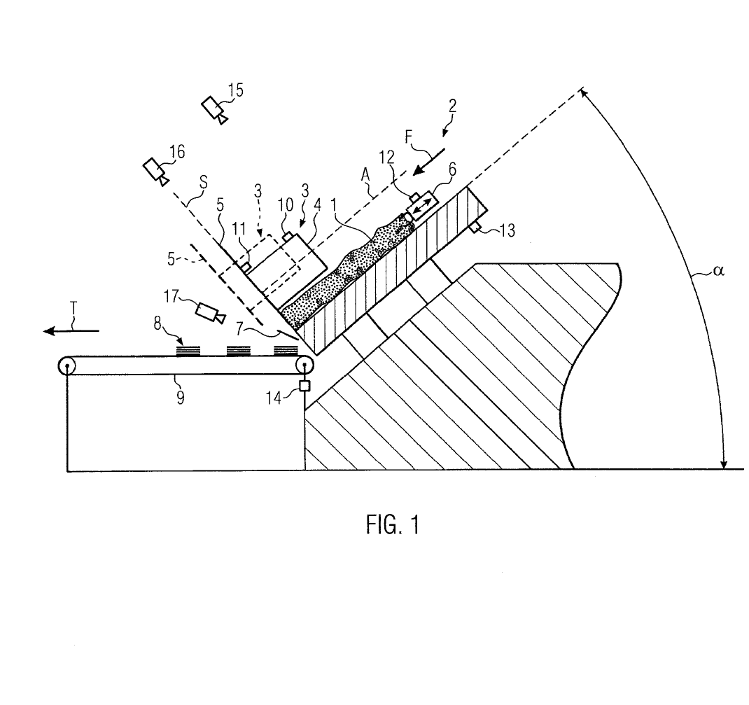

FIG. 1 shows a device for slicing a food product 1.

The food product 1 is especially a food rod such as a sausage, cheese or ham rod. The food product 1 may have a uniform cross-section or a cross-section which varies along its length.

The food product 1 is arranged on a product feeder 2 which essentially extends inclined towards a cutting unit 3. The cutting unit 3 has a drive 4 especially in the form of an electric motor with a gear essentially associated thereto and has a cutting knife 5. The cutting knife 5 may be especially formed as crescent-shaped. The cutting knife 5 rotates about a rotational axis A which extends especially in parallel to a feeding direction F of the product feeder 2. The food product 1 may be gripped at its end facing away from the cutting unit 3 by a gripper 6.

The cutting knife thereby rotates in a cutting plane S and cuts of singles slices 7 from the food product 1. After the cutting knife 5, the slices 7 are arranged into piles 8. The piles 8 are arranged on a conveying means 9 especially a conveyer belt and are further conveyed by the conveying means in a conveying direction T.

A plurality of specifications may be adjusted for the cutting unit 3. The angle a may especially be adjusted which designates to what extent the product feeder 2 is inclined with respect to the horizontal plane. Furthermore, the speed of the drive 4 may be specified. A further specification is the position of the cutting knife 5. Therefore, the cutting unit 3 is comprised of the drive 4 and the cutting knife 5 may be displaced in various positions in feeding direction F as well as the directions extending orthogonally with respect to the feeding direction F. A further position of cutting unit 3 is illustrated by dashed lines in FIG. 1.

A further specification for the cutting program is the motion of the gripper 6, especially when the gripper 6 comes into engagement with the food product 1. Furthermore, it may be determined when the gripper 6 releases the remaining food product 1 after finishing the slicing procedure. Further specifications with respect to the gripper 6 are the force which is applied by the gripper 6 to the end of the food product 1 in feeding direction F and a force with which the gripper jaws engage into the food product 1.

Further specifications of the cutting program may be the speed of the conveying means 9 in conveying direction T and the succession of halt and movement of the conveying means 9. By a slow movement of the conveying means 9 during the slicing of the food product 1, a staggered arrangement of several slices 7 in one pile 8 may especially be achieved. Furthermore, the movement of the conveying means 9 has the effect that the single piles 8 may be separated from each other.

A plurality of sensors may be provided which capture status parameters or the values or information from which status parameters may be derived. A drive sensor 10 at the drive 4 of the cutting unit may especially be provided which may capture the motor current of the drive 4, the speed of the drive 4, the temperature of the drive 4 and/or the vibration of the drive 4 as the status parameter.

Furthermore, a cutting knife sensor 11 can be provided which may capture the speed of the cutting knife 5, the temperature of the cutting knife 5 or the vibration of the cutting knife 5 as a status parameter.

The vibration is especially captured by means of acceleration sensors or strain gauges. The cutting knife sensor 11 may especially determine the point of time by capturing the acceleration as status parameter, at which the cutting knife 5 gets into engagement with the food product 1.

Furthermore, a gripper sensor 12 may be provided which especially enables capturing of the position, speed, and/or temperature of the gripper 6 as a status parameter.

Additionally, a vibration of the gripper 6 may be captured. Thereby, the feed forward movement of the food product 1 may be precisely monitored. Furthermore, an engine frame sensor 13 is provided especially at the product feeder 2 and also at another position of the engine frame. With the engine frame sensor 13, vibrations at the engine frame, especially at the product feeder 2, are captured as status parameter.

Furthermore, a conveying means sensor 14 may also be provided at the conveying means 9. With the conveying means sensor 14, for example, the weight of the single piles 8 or slices 7 may be captured as status parameter. Further, the conveying means sensor 14 in some embodiments may alternatively or additionally capture vibrations at the conveying means as status parameter.

The vibrations captured by the sensors 10, 11, 12, 13, 14 mentioned above represent either status parameters or may be converted to status parameters. By monitoring the status parameters it may be determined whether a predefined condition was met which especially requires a maintenance measure. For example, a predefined condition may be met by an increase of the vibrations at one of the sensors whereupon a predefined maintenance measure is required, for example, the replacement or a re-sharpening of the cutting knife 5. At the same time, it may be predicted based on the progression of the status parameters when the maintenance measure is necessary.

As a general rule, different parts are provided in machines which may lead to a failure of the device, e.g. due to wear, during the time of operation. By a prediction of the machine failures, idle times due to said failures may be minimized. Furthermore, corresponding spare parts may be prophylactically replaced or the required spare parts may be already provided in order to optimize the repair time.

By the monitoring of the status parameters it may especially be calculated in advance, when certain parts will fail. The advance calculation also takes into account the specifications which are made within a control system especially for the cutting program.

For example, a constantly rising temperature of the drive or an increase of the motor current of the drive may be recognized and it may be calculated therefrom for how long the drive can still be operated until a failure occurs. This may be carried out in dependency on the specifications for different cutting programs or also in dependency of the specifications for different products.

A possible status parameter which may be monitored is the cutting pressure which is applied at the cutting edge of the knife This may be determined either directly at the knife or indirectly by a measurement at the drive. For example, an increased motor temperature or an increased motor current may be a hint for a required re-sharpening of the knife or to the end of the lifetime of the knife.

During the operation, reference parameters may especially be captured which may be compared in relation to the status parameters in order to enable conclusions about changes in the status of parts.

According to the disclosure, additionally the at least one specification selected in the control system is considered during the calculation of a predefined condition so that not only in dependency on the status parameters, but also in dependency of the specifications of the control system it may be determined whether a proper operation of the device is at hand.

For example, after maintenance, a set of status parameters may be captured for the respectively selected specification of a cutting program which set of status parameters is then stored as reference values. A change of the status parameters starting from these reference values is monitored wherein a predefined deviation requires a maintenance measure.

With devices in the form of slicers for slicing a food product 1, the motor temperature of the drive 4 is captured, whereby conclusions about the temperature of the cutter housing result, which may influence the product temperature and may thereby be a value relevant for hygiene. Should a temperature at the drive 4 be too high, from which a status parameter of the temperature of the food product may be calculated, which fulfils a predefined condition, a warning signal is output or the speed of the drive is adjusted so that hygiene requirements may be fulfilled. The predefined condition may depend on the specification of the type of food product. Alternatively, the temperature of the food product 1 may also be captured directly.

Furthermore, the motor current of the motor, which enables the forward feed of the food product 1, can be captured in the gripper 6. While the gripper 6 is approaching the product 1, it can therefore be determined when a contact occurs in between the gripper and the product 1. Further, it can be determined by means of the motor current, whether a further forward feed of the product 1 is not feasible anymore due to operational reasons, for example because of a malfunction.

In particular, the motor current of the drive of the gripper jaws may be captured since with this motor current it may be determined whether the gripper is safely in contact with the product.

A further status parameter which may be captured directly is the oscillation of the cutting edge of the cutting knife 5. By means of an acceleration sensor or a strain gauge, at the cutting knife, thereby a contact between the cutting knife and the food product may be recognized.

Cameras may also be utilized for monitoring the status parameters wherein the cameras may fulfill the object underlying the disclosure also independently from the monitoring of the status parameters.

In FIG. 1, a feed forward camera 15 is provided which may monitor the feed forward process of the food product 1 on the product feeder 2. The camera 15 may especially capture the respective positions of the food product 1 and the gripper 6 and may determine therefrom also status parameters, for example like the feed forward speed. Furthermore, the feed forward camera may monitor the orientation of the food product 1, especially the centre orientation. The food product 1 is furthermore, in certain embodiments, in abutment with lateral limit stops. The feed forward camera may monitor whether the food product 1 is in contact with at least one lateral limit stop as defined.

Furthermore, a cutting unit camera 16 may be provided. The cutting unit camera is especially arranged in the cutting plane S. The cutting unit camera 16 enables monitoring of the proper operation of the cutting knife 5. It may be especially monitored whether the knife corresponds to the geometric requirements of the device. This, for example, may not be the case if the knife has been re-sharpened too often. Furthermore, it may be checked whether the used knife is an original equipment part. The camera may also capture the dynamic behaviour of the cutting knife and can thereby determine whether, or where, a malfunction of the device is at hand.

Further, a cutting process camera 17 may be provided which may be especially directed onto the cut surface of the food product 1 and/or the upper slice of the pile 8. The cutting process camera may on the one hand monitor the cutting process while it is carried out and may on the other hand capture the products of the cutting process, namely, the slices 7 and may determine whether they have the desired status parameters. The form, orientation, size or thickness of the slices or of the cut surface at the food product 1 may especially be captured as status parameter or information.

Additionally, a relative arrangement of the single slices 7 on the pile 8 may be controlled.

The cameras 15, 16, 17 capture light with wavelengths in the visible spectrum.

As an alternative to thermal imaging cameras, any desired other contactless temperature sensor may also be employed for capturing status parameters relating to temperature.

If an adverse temperature is at hand, the operating staff of the device may be provided with a signal. At the same time, a recommendation for a further cause of action may be output by this signal like e.g. the proposal to change the cutting speed. Furthermore, the cutting speed may also be changed automatically.

Moreover, the operator may also be provided with a signal or hint under a certain lead time which signal draws the attention of the operator to the near required replacement or re-sharpening, respectively, of the cutting knife 5.

It is especially advantageous to capture the temperature of the cut surface of the recently cut slices 7 and the cut surface of the food product 1, respectively, since this represents a status parameter or therefrom at least one status parameter of the cutting process may be derived.

Commonly, a higher temperature occurs when the cutting knife 5 no longer has a predefined or desired sharpness.

The temperature of the food product 1 to be sliced may especially be measured directly before the slicing. This information may be evaluated and/or stored in order to evaluate predefined conditions. Therefore, it may be determined when and/or why the cutting knife no longer has the desired sharpness.

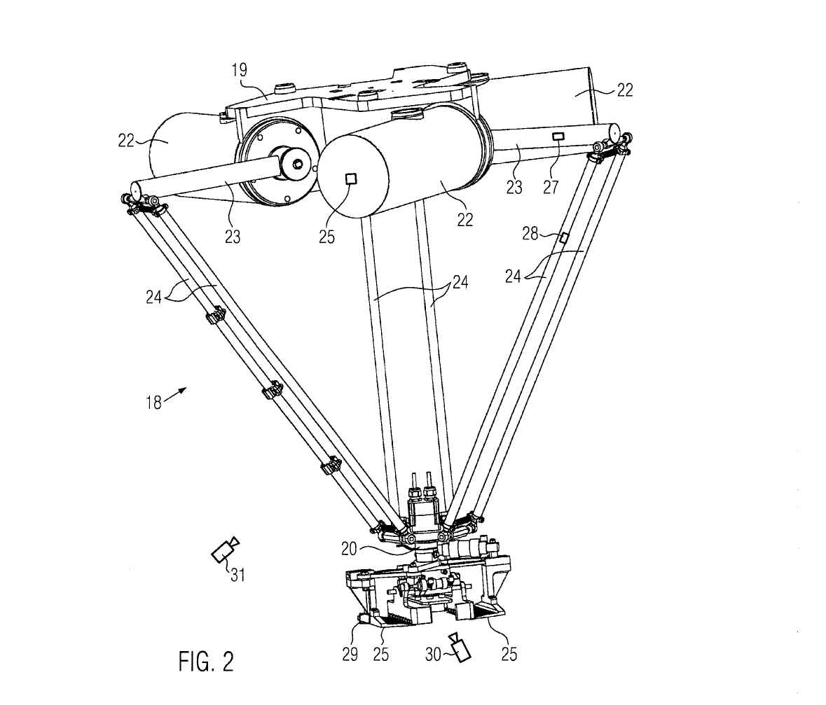

FIG. 2 shows an embodiment of a device according to the present disclosure with a robot for displacing a food product. The robot 18 especially has a delta-kinematic. At its upper end, the robot 18 has a suspension 19 and at its lower end, a tool holder 20 to which especially a gripper 21 is attached. At the suspension 19, three drives 22 in the form of electric servo motors are provided at each of which an upper robot arm 23 is provided which may be pivoted by the help of the drives 22. At an end of the upper robot arm 23, lying opposite to the drive 22, pivotable lower robot arms 24 are provided which extend to the tool holder 20, at which they are also pivotally attached. Two parallel lower robot arms 24 are especially provided for each upper robot arm 23.

The predefined kinematic has the effect that the grippers 21 may be rapidly moved and thereby a food product may be efficiently displaced. The gripper 21 especially has two gripping surfaces 25 opposing each other which may be distanced from each other and driven towards each other so that they may take up food products, especially a pile of sliced food products, with their supporting parts extending essentially horizontally.

According to the disclosure, at least one status parameter of the robot mentioned above is monitored and in dependency on the motion program, it is determined whether a predefined condition was met that especially requires a maintenance measure.

For example, the drive current for the robot arms 23 may be captured with a drive sensor 26. Alternatively, or additionally, the speed of the robot arms may be captured with an incremental encoder within the drive sensor 26. Furthermore, the drive sensor 26 may capture the temperature of the drive 22. In some embodiments it is also possible that the drive sensor captures a vibration of the drive 22. The drive sensor 26 may either be provided on only one drive 22, on several drives 22 or on all drives 22. Furthermore, robot arm sensors 27, 28 may also be provided at upper and/or lower robots arms 23, 24. The upper and the lower robot arm sensors 27, 28 may especially capture the vibration that means the acceleration, but also the inclination and/or position of the robot arms 23, 24. From the position, for example, also the speed of the robot arms 23, 24 may be derived.

Furthermore, a gripper sensor 29 may be provided at the gripper 21, with which the position, the speed, acceleration and/or vibrations of the gripper 21 may be captured. The gripper sensor 29 may also determine a temperature at the gripper or a temperature of a food product seized by the gripper.

Additionally or alternatively, cameras 30, 31 may also be provided at the device with the robot 18. The cameras 30, 31 may be either attached on the device in a stationary manner, or at the robot 18 so that they move synchronously therewith.

A gripper camera 30 is arranged such, that the gripper 21 is visually captured. In this process, the gripper camera 30 may be either attached to the gripper 21 so that it moves together with the gripper 21, or may be attached in a stationary manner especially in an end position of the gripper 21 so that it captures the gripper 21 when it is in its end position. The camera 30 may be especially mounted on the surface from which the food products are picked up or onto which the food products are placed. With the camera 30 and a suitable processing unit, especially a status parameter and/or information relating to the gripper 21 and/or to the food product 1 may be captured. The position of the food product, respectively, of the centre point or centroid of the food product may especially be captured in order to decide whether the food product may be safely picked up or has been placed in a proper manner, respectively. Furthermore, the gripper camera 30 may capture whether the gripper surfaces 25 are functioning properly especially if they assume the predefined positions and carry out the predefined movements.

Moreover, a robot camera 31 may be provided which may at least partly or entirely visually capture the robot 18. The robot camera 31 may determine especially the positions of the single robot arms 23, 24 in order to monitor a proper operation of the robot. Furthermore, the robot camera may also monitor the position of the gripper 21 and may thereby also monitor its movements.

From the information which is captured by the cameras 15, 16, 17, 30, 31, status parameters of the device may be calculated by means of which, in dependency on the specifications, it may be determined whether a predefined condition is met which especially requires a maintenance measure. Alternatively, the predefined condition may also require an emergency shut-down.

The information provided by the camera may be evaluated and the device may inform an operator about operating conditions and may give hints for suitable adjustments. Furthermore, the camera may enable that a wear of different parts is captured, for example, by capturing a false position of certain parts or incorrect motion behavior of the robot. Furthermore, it may be calculated from the change of the information captured by the camera and the status parameters calculated therefrom over time, when repair or maintenance measures are to be expected.

1. A device for slicing a food product, with comprising:
a cutting unit, in particular a rotating cutting knife, which is capable of being driven by a drive,
a product feeder, which feeds the food product to the cutting unit,
a receiving unit, which is adapted to receive food product slices, which are cut off the food product, and
a control system in which at least one specification is stored, wherein the control system is adapted to monitor at least one status parameter and to determine, in dependency on the at least one status parameter and the at least one specification, whether a predefined condition was met, which especially requires a maintenance measure.

2. The device according to claim 1, wherein the control system is adapted to store at least one specification for a cutting program, which at least one specification is selected from a plurality of specifications for cutting programs, and to determine, in dependency on the at least one status parameter and the at least one selected specification of the cutting program, whether a predefined condition was met, which especially requires a maintenance measure.

3. The device according to claim 1, wherein the status parameter is the temperature of the drive.

4. The device according to claim 1, wherein the drive is an electric motor and a status parameter is the motor current of the electric motor.

5. The device according to claim 1, wherein a gripper with a gripper drive is provided, wherein the gripper is adapted to be brought into engagement with the food product during the slicing of the food product, and wherein a status parameter is the motor current of the gripper drive.

6. The device according to claim 1, wherein a status parameter is the cutting pressure of the cutting unit.

7. The device according to claim 1, wherein a status parameter is a vibration intensity and/or frequency at the device.

8. The device according to claim 1, wherein a status parameter is the oscillation intensity at the cutting edge of the cutting knife.

9. The device according to claim 1, wherein a status parameter is the temperature of the food product directly before the slicing, or of the sliced food product slices directly after the slicing.

10. The device according to claim 1, wherein the specifications of the cutting program comprise the cutting speed of the cutting unit, the type of food product and/or the feed rate of the food product.

11. The device according to claim 1, wherein the control system is adapted to apply the at least one specification of the cutting program against the at least one status parameter in order to determine whether the predefined condition was met.

12. The device according to claim 1, wherein the predefined condition is met when leaving a tolerance region for the status parameter, wherein the tolerance region is determined in dependency of the at least one specification of the cutting program.

13. The device according to claim 1, wherein the cutting knife of the cutting unit is equipped with a sensor for capturing the at least one status parameter.

14. A device with a robot for displacing a food product, especially slices of food products, wherein the robot is provided with at least one robot arm, at which a gripping unit for picking up the food product is located, and wherein the robot is adapted to seize food products from a surface and to displace the food products to a desired location,
wherein the device is provided with a control system in which at least one specification for a motion program for the robot is stored,
wherein the control system is adapted to monitor at least one status parameter, and to determine, in dependency on the at least one status parameter and the motion program, whether a predefined condition was met, which especially requires a maintenance measure.

15. The device according to claim 14, wherein the control system is adapted to store the at least one specification for a motion program, which at least one specification was selected from a plurality of specifications for motion programs, wherein the control system is adapted to additionally determine in dependency on the at least one selected specification, whether the predefined condition was met.

16. The device according to claim 14, wherein the at least one robot arm has an electric drive, and a status parameter is the supply current of this drive.

17. The device according to claim 14, wherein the at least one robot arm is provided with an electric drive, and a status parameter is the temperature of this drive.

18. The device according to claim 14, wherein a status parameter is the position and/or the speed of the at least one robot arm, wherein this is especially captured by means of an incremental encoder.

19. The device according to claim 14, wherein a camera is provided, which captures a status parameter of the device.

20. The device according to claim 19, wherein the camera and the control system are adapted to determine the position of the food product slices as a status parameter.

21. The device according to claim 19, wherein the camera and the control system are adapted to determine a centre point of the food product slices as a status parameter.

22. The device according to claim 14, wherein the control system is adapted to adjust an operation parameter of the device, if the predefined condition was met.

23. The device according to claim 14, wherein the control system is adapted to output a warning signal, if the predefined condition was met.

24. The device according to claim 14, wherein the control system is adapted to continuously monitor the at least one status parameter.

25. The device according to claim 1, wherein the control system is adapted so that the at least one status parameter is monitored at discrete sample points.

26. The device according to claim 24, wherein the control system is adapted to determine by evaluating a status parameter of different points of time whether the predefined condition was met.

27. The device according to claim 1, wherein the control system is adapted to take into account at least one status parameter in the calculation of the predefined condition.

28. The device according to claim 1, wherein a memory element is provided, which is adapted to store the status parameters.

29. A device for slicing a food product, comprising:
a cutting unit, in particular a rotating cutting knife, which is able to be driven by a drive,
a product feeder, which feeds the food product to the cutting unit, and
a receiving unit, which is adapted to receive food product slices, which are cut off the food product,
wherein at least one camera is provided, which is adapted to capture at least one information in relation to the cutting unit and/or the food product, respectively the food product slices.

30. The device according to claim 29, wherein the camera is adapted to monitor the orientation of the food product.

31. The device according to claim 29, wherein the camera is adapted to monitor the structure or size of the food product slices.

32. The device according to claim 29, wherein the camera is adapted to monitor the wear of the cutting knife.

33. The device according to claim 29, wherein the camera is adapted to determine the form of the loaded cutting knife.

34. A device with a robot for displacing a food product, especially food product slices, wherein the robot is provided with at least one robot arm, at which a gripping unit for picking up the food products is located, and wherein the robot is adapted to seize food products from a surface and to displace the food products to a desired location,
wherein at least one camera is provided, which is adapted to capture information in relation to the robot and/or the food product.

35. The device according to claim 34, wherein the camera is adapted to determine the position of the food product slices.

36. The device according to claim 34, wherein the camera is adapted to determine the centre point of the food product slices.

37. The device according to claim 34, wherein the camera is adapted to determine the position of the gripping unit.

38. The device according to claim 29, wherein the device is provided with a control system which is adapted to monitor at least one status parameter, which is determined based on information provided by the camera, and to determine whether in dependency on the at least one status parameter a predefined condition was met, which requires a measure, especially a maintenance measure.

39. The device according to claim 29, wherein a memory element is provided which is adapted to store the information detected by the camera.
